(19) United States
(12) Patent Application Publication
(10) Pub. No.: US 2026/0095744 A1
(43) Pub. Date: Apr. 2, 2026

(54) DEVICES, METHODS AND APPARATUSES FOR RECONFIGURATION OPERATION

(71) Applicant: Nokia Technologies Oy, Espoo (FI)

(72) Inventors: Henri Markus KOSKINEN, Espoo (FI); Xiang XU, Jiangsu (CN)

(21) Appl. No.: 19/113,488

(22) PCT Filed: Sep. 29, 2022
(86) PCT No.: PCT/CN2022/122905

§ 371 Date: Mar. 20, 2025

(51) Int. Cl. H04W 8/18

(52) U.S. Cl. CPC H04W 8/18

(57) ABSTRACT

Embodiments of the present disclosure disclose devices, methods and apparatuses for reconfiguration control. A terminal device receives, from a first network device, indication information on at least one reconfiguration performing condition related to data transfer status regarding one or more applications. Then, the terminal device performs a reconfiguration operation based on determining that the at least one reconfiguration performing condition is fulfilled. In this way, the terminal device may perform reconfiguration with an optimized execution time, thereby minimizing service disruption.

### FIELD

Embodiments of the present disclosure generally relate to the field of communication, and in particular, to devices, methods, apparatuses and computer readable storage medium for reconfiguration operation.

### BACKGROUND

With the development of communication technology, extended reality, XR, has been introduced to improve communication performance. The XR encompasses any technology that alters reality by adding digital elements to the physical or real-world environment, e.g. augmented reality, AR, mixed reality, MR and virtual reality, VR. Considering the XR/media traffics have a natural interval between periodic video/audio frames, it would be possible to enhance the mobility management and power saving mechanisms considering the XR/media traffic pattern. In the area of XR, user experience is an important factor.

Currently, XR enhancement may comprise potential enhancements of mobility and power management considering traffic pattern of media services and support handover enhancement to minimize service disruption. However, further XR enhancement is still needed to further improve user experience in reconfiguration operation.

### SUMMARY

In general, example embodiments of the present disclosure provide devices, methods, apparatuses and computer readable storage medium for reconfiguration control.

In a first aspect, there is provided a terminal device. The terminal device may comprise one or more transceivers; and one or more processors communicatively coupled to the one or more transceivers, and the one or more processors are configured to cause the terminal device to: receive, from a first network device, indication information on at least one reconfiguration performing condition related to data transfer status regarding one or more applications; and perform a reconfiguration operation based on determining that the at least one reconfiguration performing condition is fulfilled.

In a second aspect, there is provided a first network device. The first network device may comprise one or more transceivers; and one or more processors communicatively coupled to the one or more transceivers, and the one or more processors are configured to cause the first network device to: receive, from a second network device, indication information on at least one reconfiguration performing condition related to data transfer status regarding one or more applications, wherein the at least one reconfiguration performing condition is for a reconfiguration message; and transmit, to a terminal device, the indication information on at least one reconfiguration performing condition, to indicate the terminal device to perform a reconfiguration operation based on the at least one reconfiguration performing condition.

In a third aspect, there is provided a first network device. The first network device may comprise one or more transceivers; and one or more processors communicatively coupled to the one or more transceivers, and the one or more processors are configured to cause the first network device to: receive, from a second network device, delaying transfer information related to data transfer status regarding one or more applications, wherein the delaying transfer information is for a reconfiguration message; and transmit the reconfiguration message to the terminal device based on the delaying transfer information.

In a fourth aspect, there is provided a second network device. The second network device may comprise one or more transceivers; and one or more processors communicatively coupled to the one or more transceivers, and the one or more processors are configured to cause the second network device to: transmit, to a first network device, reconfiguration control information related to data transfer status regarding one or more applications, wherein the reconfiguration control information is for a reconfiguration message.

In a fifth aspect, there is provided a method implemented at a terminal device. The method may comprise: receiving, from a first network device, indication information on at least one reconfiguration performing condition related to data transfer status regarding one or more applications; and performing a reconfiguration operation based on determining that the at least one reconfiguration performing condition is fulfilled.

In a sixth aspect, there is provided a method implemented at a first network device. The method comprises: receiving, from a second network device, indication information on at least one reconfiguration performing condition related to data transfer status regarding one or more applications, wherein the at least one reconfiguration performing condition is for a reconfiguration message; and transmitting, to a terminal device, the indication information on at least one reconfiguration performing condition, to indicate the terminal device to perform a reconfiguration operation based on the at least one reconfiguration performing condition.

In a seventh aspect, there is provided a method implemented at a first network device. The method may comprise: receiving, from a second network device, delaying transfer information related to data transfer status regarding one or more applications, wherein the delaying transfer information is for a reconfiguration message; and transmitting the reconfiguration message to the terminal device based on the delaying transfer information.

In an eighth aspect, there is provided a method implemented at a second network device. The method may comprise: transmitting, to a first network device, reconfiguration control information related to data transfer status regarding one or more applications, wherein the reconfiguration control information is for a reconfiguration message.

In a ninth aspect, there is provided an apparatus of a terminal device. The apparatus may comprise: means for receiving, from a first network device, indication information on at least one reconfiguration performing condition related to data transfer status regarding one or more applications; and means for performing a reconfiguration operation based on determining that the at least one reconfiguration performing condition is fulfilled.

In a tenth aspect, there is provided an apparatus of a first network device. The apparatus may comprise: means for receiving, from a second network device, indication information on at least one reconfiguration performing condition related to data transfer status regarding one or more applications, wherein the at least one reconfiguration performing condition is for a reconfiguration message; and means for transmitting, to a terminal device, the indication information on at least one reconfiguration performing condition, to indicate the terminal device to perform a reconfiguration operation based on the at least one reconfiguration performing condition.

In a eleventh aspect, there is provided an apparatus of a first network device. The apparatus may comprise: means for receiving, from a second network device, delaying transfer information related to data transfer status regarding one or more applications, wherein the delaying transfer information is for a reconfiguration message; and means for transmitting the reconfiguration message to the terminal device based on the delaying transfer information.

In a twelfth aspect, there is provided an apparatus of a second network device. The apparatus may comprise: means for transmitting, to a first network device, reconfiguration control information related to data transfer status regarding one or more applications, wherein the reconfiguration control information is for a reconfiguration message.

In a thirteenth aspect, there is provided a terminal device. The terminal device may comprise at least one processor; and at least one memory including computer program codes, wherein the at least one memory and the computer program codes are configured to, with the at least one processor, cause the terminal device to: receive, from a first network device, indication information on at least one reconfiguration performing condition related to data transfer status regarding one or more applications; and perform a reconfiguration operation based on determining that the at least one reconfiguration performing condition is fulfilled.

In a fourteenth aspect, there is provided a first network device. The first network device may comprise at least one processor; and at least one memory including computer program codes, wherein the at least one memory and the computer program codes are configured to, with the at least one processor, cause the first network device to: receive, from a second network device, indication information on at least one reconfiguration performing condition related to data transfer status regarding one or more applications, wherein the at least one reconfiguration performing condition is for a reconfiguration message; and transmit, to a terminal device, the indication information on at least one reconfiguration performing condition, to indicate the terminal device to perform a reconfiguration operation based on the at least one reconfiguration performing condition.

In a fifteenth aspect, there is provided a first network device. The first network device may comprise at least one processor; and at least one memory including computer program codes, wherein the at least one memory and the computer program codes are configured to, with the at least one processor, cause the first network device to: receive, from a second network device, delaying transfer information related to data transfer status regarding one or more applications, wherein the delaying transfer information is for a reconfiguration message; and transmit the reconfiguration message to the terminal device based on the delaying transfer information.

In a sixteenth aspect, there is provided a second network device. The second network device may comprise at least one processor; and at least one memory including computer program codes, wherein the at least one memory and the computer program codes are configured to, with the at least one processor, cause the second network device to: transmit, to a first network device, reconfiguration control information related to data transfer status regarding one or more applications, wherein the reconfiguration control information is for a reconfiguration message.

In a seventeenth aspect, there is provided a non-transitory computer readable medium comprising program instructions for causing an apparatus to perform at least the method according to any of fifth to eighth aspect.

In an eighteenth aspect, there is provided a computer program comprising instructions, which, when executed by an apparatus, cause the apparatus at least to: receive, from a first network device, indication information on at least one reconfiguration performing condition related to data transfer status regarding one or more applications; and perform a reconfiguration operation based on determining that the at least one reconfiguration performing condition is fulfilled.

In a nineteenth aspect, there is provided a computer program comprising instructions, which, when executed by an apparatus, cause the apparatus at least to: receive, from a second network device, indication information on at least one reconfiguration performing condition related to data transfer status regarding one or more applications, wherein the at least one reconfiguration performing condition is for a reconfiguration message; and transmit, to a terminal device, the indication information on at least one reconfiguration performing condition, to indicate the terminal device to perform a reconfiguration operation based on the at least one reconfiguration performing condition.

In a twentieth aspect, there is provided a computer program comprising instructions, which, when executed by an apparatus, cause the apparatus at least to: receive, from a second network device, delaying transfer information related to data transfer status regarding one or more applications, wherein the delaying transfer information is for a reconfiguration message; and transmit the reconfiguration message to the terminal device based on the delaying transfer information.

In a twenty-first aspect, there is provided a computer program comprising instructions, which, when executed by an apparatus, cause the apparatus at least to: transmit, to a first network device, reconfiguration control information related to data transfer status regarding one or more applications, wherein the reconfiguration control information is for a reconfiguration message.

In a twenty-second aspect, there is provided a terminal device. The terminal device comprises receiving circuitry configured to: receive, from a first network device, indication information on at least one reconfiguration performing condition related to data transfer status regarding one or more applications; and performing circuitry configured to: perform a reconfiguration operation based on determining that the at least one reconfiguration performing condition is fulfilled.

In a twenty-third aspect, there is provided a first network device. The first network device comprises receiving circuitry configured to: receive, from a second network device, indication information on at least one reconfiguration performing condition related to data transfer status regarding one or more applications, wherein the at least one reconfiguration performing condition is for a reconfiguration message; and transmitting circuitry configured to: transmit, to a terminal device, the indication information on at least one reconfiguration performing condition, to indicate the terminal device to perform a reconfiguration operation based on the at least one reconfiguration performing condition.

In a twenty-fourth aspect, there is provided a first network device. The first network device comprises receiving circuitry configured to: receive, from a second network device, delaying transfer information related to data transfer status regarding one or more applications, wherein the delaying transfer information is for a reconfiguration message; and transmitting circuitry configured to: transmit the reconfiguration message to the terminal device based on the delaying transfer information.

In a twenty-fifth aspect, there is provided a second network device. The second network device comprises transmitting circuitry configured to: transmit, to a first network device, reconfiguration control information related to data transfer status regarding one or more applications, wherein the reconfiguration control information is for a reconfiguration message.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates an example signaling process for the reconfiguration control according to some embodiments of the present disclosure;

FIG. 3 is an example of protocol data unit (PDU) sets which may be used in example embodiments of the present disclosure;

FIG. 4 is an example of quality of service (QoS) media classification which may be used in example embodiments of the present disclosure;

FIG. 5 illustrates another example signaling process for the reconfiguration control according to some embodiments of the present disclosure;

FIG. 6 illustrates an example flowchart of a method implemented at a terminal device according to example embodiments of the present disclosure;

FIG. 7 illustrates an example flowchart of a method implemented at a first network device according to example embodiments of the present disclosure;

FIG. 8 illustrates an example flowchart of a method implemented at a first network device according to example embodiments of the present disclosure;

FIG. 9 illustrates an example flowchart of a method implemented at a second network device according to example embodiments of the present disclosure;

FIG. 10 illustrates an example simplified block diagram of an apparatus that is suitable for implementing embodiments of the present disclosure; and

FIG. 11 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a central unit (CU), a distributed unit (DU), a radio header (RH), a remote radio head (RRH), a relay, a master node (MN), a secondary node (SN), an integrated access and backhaul (IAB) node, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The term “IAB” refers to a technology that allows for multi-hop backhauling using the same frequencies employed for user equipment access or a distinct, dedicated, frequency. IAB enables wireless relaying in NG-RAN. The relaying node, referred to as IAB-node, supports access and backhauling via NR. The terminating node of NR backhauling on the network side is referred to as the IAB-donor, which represents a gNB with additional functionality to support IAB. Backhauling can occur via a single or multiple hops. The IAB-node supports the gNB-DU functionality, as defined in Technical specification (TS) 38.401 [4], to terminate the NR access interface to UEs and next-hop IAB-nodes, and to terminate the F1 protocol to the gNB-CU functionality, as defined in TS 38.401 [4], on the IAB-donor. The gNB-DU functionality on the IAB-node is also referred to as IAB-DU. In addition to the gNB-DU functionality, the IAB-node also supports a subset of the UE functionality referred to as IAB mobile termination (IAB-MT), which includes, e.g., physical layer, layer-2, radio resource control (RRC) and NAS functionality to connect to the gNB-DU of another IAB-node or the IAB-donor, to connect to the gNB-CU on the IAB-donor, and to the core network.

The term “DU” refers to a distributed unit, DU, close to RU, responsible for a part of functionalities of radio link control layer, medium access control layer, and physical layer. The term “CU” refers to a central unit for higher layer protocols such as radio resource control, RRC, layer, packet data convergence protocol, PDCP, layer.

The term “dual connectivity (DC)” refers to a connection mode in which the UE may be configured with two MAC entities, one of which is associated with a master cell group (MCG) provided by a master node (MN) to which the UE's primary cell (PCell) belongs, and the other of which is associated with a secondary cell group (SCG) provided by a secondary node (SN) to which the UE's primary secondary cell (PSCell) belongs. The UE can be configured with different types of DRBs.

In the ongoing 3GPP Release (Rel) 18, work on mobile IAB and inter-donor-gNB mobility of an IAB node, the meeting Radio Access Network (RAN)3 #117 has reached the following agreement: the UEs connected to the mobile IAB-node are handed over from the cell of the logical mobile IAB-distributed unit, DU, (i.e., the source logical mobile IAB-DU) that has an F1 application protocol, F1AP, association with the source central unit, CU, to the cell of the logical mobile IAB-DU (i.e., the target logical mobile IAB-DU) that has an F1AP association with the target CU.

That is, the mobile IAB node is modelled as having two DUs (e.g. DU1 and DU2) between which UEs are handed over as part of the IAB-node mobility procedure. For example, DU1 may connect with source gNB-CU (i.e. IAB-donor-CU1), and DU2 may connect with target gNB-CU (i.e. IAB-donor-CU2). To support the full migration from IAB-donor-CU1 to IAB-donor-CU2, both DUs (and the associated cells) are active simultaneously, in order to hand over the connected UEs from DU1 to DU2. Since both DUs are active simultaneously, the handover for the connected UEs can be performed over a period of time, instead of having to hand over all UEs in a single time instant.

The inventors notice that currently, the time of execution of a handover command by a UE (in case of conditional handover where the command itself is sent to the UE well beforehand), or the time of sending of a non-conditional (to be executed immediately upon reception) handover command to a UE by the network is mainly based on the radio condition. No other conditions such as possible different data-burst phases of the UE are taken into account. This might be because:
For the UE, no such execution conditions have been specified, nor freedom allowed, in the standards;
To the gNB DU, the content of RRC messages (such as measurement reports or handover commands), to be relayed between the UE and the gNB CU, is not visible due to ciphering. Therefore, the DU cannot know whether the purpose of a downlink RRC message to a UE is an urgent handover to avoid the UE suffering radio-link failure;
The gNB CU-CP that sends the handover command towards the UE has no visibility on data-burst phases, or the data buffered in the UE.

In addition, the inventors notice that in handover operation, there are non-urgent scenarios, examples of which may include:
UE handover from the source logical DU of a mobile IAB node, to the target DU hosted by the same IAB node;
Load-balancing handover between different frequencies.

These examples are not urgent since the handover is not a consequence of the UE's radio-channel conditions.

However, according to the current standards, once a UE-handover command is sent by a gNB CU (and in case of conditional handover the conditions at the UE are fulfilled), the handover is always performed as soon as possible, even in cases where in fact it could be postponed until the next time when the UE's data-transfer buffers are empty. This means:
For data over acknowledged-mode bearers, an unnecessary delay to the data whose delivery ends up postponed until after the handover;
For data over unacknowledged-mode bearers, unnecessary data loss (because there is no PDCP-level retransmission for data submitted to RLC before the handover),
   The above issues may have adverse impacts on user experience.

In addition to handover, the problem is equally valid for SCG change in DC scenario. As a matter of the fact, it is true for any reconfiguration procedure, which entails the re-establishment or release of an RLC entity for one or more DRBs. Examples include reconfiguration procedure for SCG change i.e. “handover” of only the UE's SCG, or bearer-type change of a DRB among MCG bearer, split bearer, and SCG bearer.

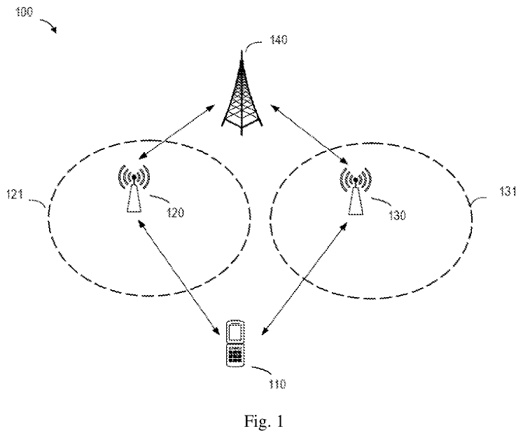

According to embodiments of the present disclosure, there is provided a new solution for conditional reconfiguration operation. In this solution, a terminal device receives, from a first network device, indication information on at least one reconfiguration performing condition related to data transfer status regarding one or more applications. Moreover, the terminal device performs a reconfiguration operation based on determining that the at least one reconfiguration performing condition is fulfilled. As such, the execution time of the applicable procedure relative to data bursts may be optimized, thereby performing the handover or other applicable procedure (which causes interruption) without affecting the user experience. Example embodiments of the present disclosure for determination of the terminal device's identity will be described below with reference to FIGS. 1-11.

FIG. 1 illustrates an example network environment 100 in which example embodiments of the present disclosure may be implemented. The environment 100, which may be a part of a communication network, comprises a first device 110, a second device 120, a third device 130, as well as a fourth device 140. The first device 110 may be implemented as the terminal device (which may be also referred to as the terminal device 110 or UE 110 hereinafter). The second device 120 and the third device 130 may be implemented as first network devices (which may include, be implemented as, or be referred to as DUs 120 and 130, SNs 120 and 130 or first network devices 120 and 130), such as base stations for providing radio coverage to the first device 110. The fourth device 140 may be implemented as the second network device (which may include, be implemented as, or be referred to as CU 140 or MN 140).

The second device 120 and the third device 130 may provide and manage serving cells 121 and 131. The first device 110 may communicate with the second device 120 and the third device 130 in the coverage of serving cells 121 and 131. The first device 110 may communicate with the fourth device 140 via the second device 120 or the third device 130. The first device 110 may undergo handover between the second device 120 and the third device 130. In some scenarios, the DU 120 and the DU 130 may connect with a same CU i.e. CU 140. The DU 120 and the DU 130 may also connect with two different CUs respectively (not shown in FIG. 1). It is to be understood that the number of serving devices shown in the environment 100 is only for the purpose of illustration, but without any limitation to the scope of the present disclosure. Depending on implementation scenario, network deployment, resource configuration, actual demands, etc., there may be different number of devices.

In DC scenario, the first device 110 may be configured with a master cell group (which may be also referred to as MCG hereinafter) provided by the second network device and a secondary cell group (which may be also referred to as SCG hereinafter) provided by the first network device. The second device 120 and the third device 130 provides and manages the SCGs including more than one serving cells, respectively, and the fourth device 140 provides and manages the MCG including more than one serving cells (not shown in FIG. 1). It is to be understood that the number of serving cells shown in the environment 100 is only for the purpose of illustration, but without any limitation to the scope of the present disclosure. Depending on implementation scenario, network deployment, resource configuration, actual demands, etc., there may be different number of serving cells.

It is to be understood that the number of network devices and terminal devices is given only for the purpose of illustration without suggesting any limitations. The system 100 may include any suitable number of network devices and/or terminal devices adapted for implementing embodiments of the present disclosure. Although not shown, it would be appreciated that one or more terminal devices may be located in the environment 100.

Communications in the network environment 100 may be implemented according to any proper communication protocol(s), comprising, but not limited to, the third generation (3G), the fourth generation (4G), the fifth generation (5G) or beyond, wireless local network communication protocols such as institute for electrical and electronics engineers (IEEE) 802.11 and the like, and/or any other protocols currently known or to be developed in the future. Moreover, the communication may utilize any proper wireless communication technology, comprising but not limited to: multiple-input multiple-output (MIMO), orthogonal frequency division multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), carrier aggregation (CA), dual connection (DC), and new radio unlicensed (NR-U) technologies.

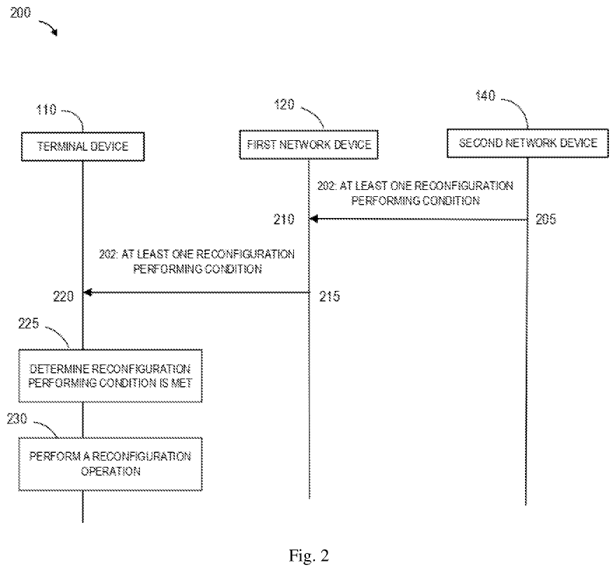

FIG. 2 illustrates an example signaling process 200 for reconfiguration control according to some embodiments of the present disclosure. For the purpose of discussion, the process 200 will be described with reference to FIG. 1. The process 200 may involve the terminal device 110, the first network device 120 and the second network device 140 as illustrated in FIG. 1. It would be appreciated that although the process 200 has been described in the communication environment 100 of FIG. 1, this process may be likewise applied to other communication scenarios with similar issues.

In the process 200, the second network device 140 may transmit 205 indication information on at least one reconfiguration performing condition 202 to the first network device 120. The at least one reconfiguration performing condition 202 may be related to data transfer status regarding one or more applications.

The indication information is related to a reconfiguration operation and used to control the performing of the reconfiguration operation. In some embodiments, the indication information is contained in a transfer message containing a reconfiguration message. In some embodiments, the indication information is contained in the reconfiguration message.

In some embodiments, the at least one reconfiguration performing condition includes ending of an active time for data transmission and reception. In some embodiments, the active time for data transmission and reception includes active time on one or more discontinuous reception, DRX, groups of at least one serving cell.

Therefore, in the present disclosure, new execution conditions for conditional handover (or conditional reconfiguration of other kind such as conditional PSCell addition or change, CPAC) are defined, which take into account data-burst phases. In an example, a condition is fulfilled when active time for one or more DRX groups of serving cells ends. The ending of active time on a DRX group suggests that the UE's data-transmission and reception activity on the DRX group has paused.

In some embodiments, the at least one reconfiguration performing condition includes that data amount in an application-layer playout buffer of the terminal device is above a predetermined threshold. In an example, a condition is fulfilled when there is enough data in the UE's application-layer playout buffer. This means that there is enough data for playout and thus such reconfiguration will not cause a bad experience to users using XR.

In some embodiments, the at least one reconfiguration performing condition includes transmission completion of all protocol data units, PDU, wherein the PDU may belong to a certain PDU set or belong to a certain data radio bearer, or belongs to a certain PDU session.

A PDU set usually includes one or more PDUs carrying the payload of one unit of information generated at the application level (e.g. a frame or video slice for XRM Services, as used in Technical Report (TR) 26.926 [27]). In some implementations, all PDUs in a PDU set is needed by the application layer to use the corresponding unit of information. In other implementations, the application layer can still recover parts all or of the information unit, when some PDUs are missing.

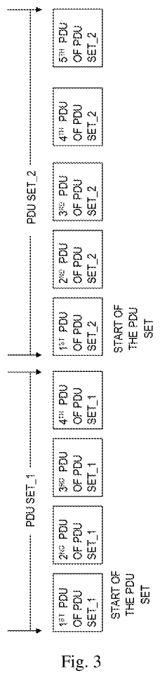

FIG. 3 is an example of PDU sets which may be used in example embodiments of the present disclosure. As shown in FIG. 3, two PDU sets are illustrated, wherein there are 4 PDUs in PDU SET_1, and there are 5 PDUs in PDU SET_2. If the reconfiguration is performed during the interval between PDU SET_1 and PDU SET_2, the impact to user experience may be avoided. In an example, a condition is fulfilled when the UE has completed receiving all PDUs belonging to a certain PDU set. The conditions may be related to a specific DRB/PDU session, e.g. used for XR service, or for streaming video service.

In some embodiments, the at least one reconfiguration performing condition includes transmission completion of all PDUs with a predetermined higher-priority PDU priority mark, PPM.

QoS handlers are provided with a PDU Priority Mark (PPM) that represents importance and dependence of PDU Set in terms of a linear priority value (e.g. high/medium/low, 0-7). PPM is related to PDU set delay budget, error rate and other parameters associated to each priority value. A QoS handler may use PPM along with PDU set boundaries to handle packets of PDU set in a flow without the need to understand the specifics of various coded media. The PPM can thus be extensible for new types of media.

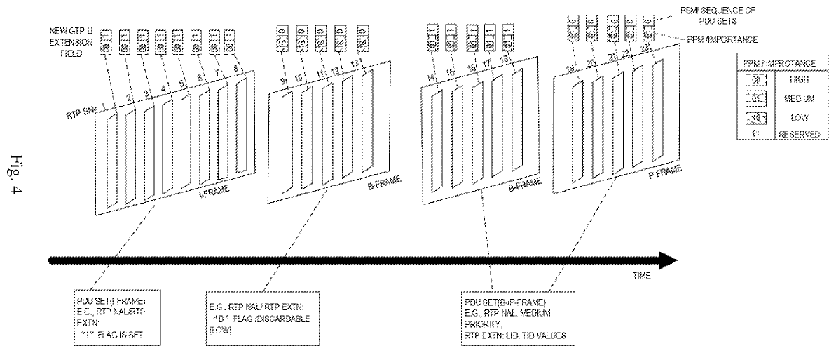

FIG. 4 is an example of QoS media classification which may be used in example embodiments of the present disclosure. As shown in FIG. 4, I-frame, B-frame and P-frame may be carried by PDU sets. As is known, the I-frame is a key frame, and thus the PDU sets carrying an I-frame is configured with a high PPM. The PDU sets carrying B-frame or P-frame may be configured with a medium PPM or a low PPM. If the reconfiguration is performed after the key frames are completely received, the UE can continue to use the already buffered data during the handover/interruption. In an example, a condition is fulfilled when the UE has completed receiving all PDUs with certain higher-priority PPM value(s), for example those PDUs carrying an I-frame.

After receiving 210 the indication information on at least one reconfiguration performing condition 202 from the second network device 140, the first network device 120 transmits 215, to a terminal device 110, indication information on the at least one reconfiguration performing condition 202 to indicate the terminal device 110 to perform 230 a reconfiguration operation based on the at least one reconfiguration performing condition 202.

In some embodiments, the indication information is comprised in a reconfiguration message, and wherein the reconfiguration message includes a radio resource control, RRC, reconfiguration message. In some embodiments, the reconfiguration message is used for any of handover between distributed units, change of secondary cell group, SCG, or bearer-type change of a data radio bearer, DRB, among a master cell group, MCG, bearer, a split bearer, and a SCG bearer.

After receiving 220 the at least one reconfiguration performing condition 202, the terminal device 110 determines 225 whether the at least one reconfiguration performing condition is fulfilled. Based on determining 225 that the at least one reconfiguration performing condition 202 is fulfilled, the terminal device 110 performs 230 a reconfiguration operation.

In some embodiments, the new conditions above can be the sole condition for the UE to execute the conditional reconfiguration. This could be e.g. in the case of a conditional handover configured to the UE for load-balancing purpose. In some embodiments, the new condition is a second-stage execution condition for the reconfiguration, whose fulfilment the UE starts to evaluate only once a configured primary condition (like the currently defined conditions related to UE's radio-measurement results) is fulfilled.

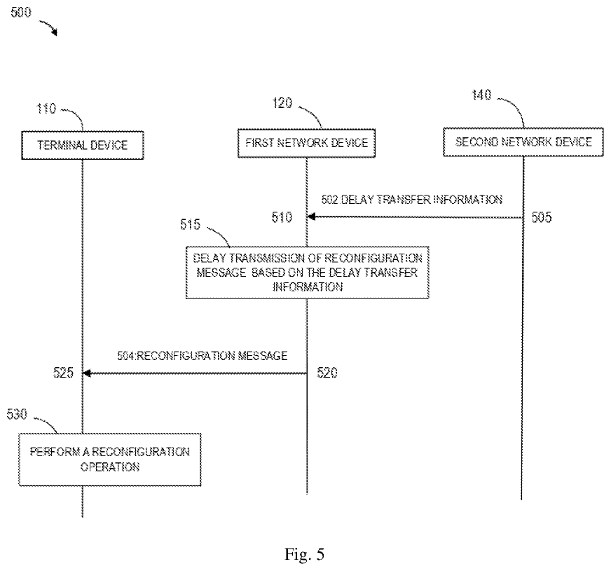

FIG. 5 illustrates another example signaling process 500 for reconfiguration control according to some embodiments of the present disclosure. For the purpose of discussion, the process 500 will be described with reference to FIG. 1. The process 500 may involve the terminal device 110, the first network device 120 and the second network device 140 as illustrated in FIG. 1. It would be appreciated that although the process 500 has been described in the communication environment 100 of FIG. 1, this process may be likewise applied to other communication scenarios with similar issues.

In the process 500, the second network device 140 transmits 505 delaying transfer information 502 related to data transfer status regarding one or more applications, wherein the delaying transfer information 502 is for a reconfiguration message.

In some embodiments, the delaying transfer information includes one or more of: an indication indicating a non-urgent delivery; a time period within which the reconfiguration message shall be transmitted; or at least one transfer condition for transmitting the reconfiguration message to the terminal device 110.

In an example, a new indication in an F1AP message carrying a downlink RRC message to the UE (i.e. most likely the F1AP message DL RRC MESSAGE TRANSFER) indicates to the receiving gNB DU that delivering the message to the UE is not urgent (and possibly also that the delivery should take data-burst phases into account). Different possibilities of such an indication include: an indication “non-urgent delivery”; an explicit delay budget or timing, i.e. a time within which the message should be delivered; a condition for delivering the RRC message to the UE.

In some embodiments, the at least one transfer condition includes one or more of: data amount in all data buffers associated with the terminal device is zero or below a certain threshold; or data amount in data buffers belonging to a certain data radio bearer is zero or below a certain threshold; transmission completion of all protocol data units belonging to certain PDU set; or, transmission completion of all protocol data units with predetermined higher-priority PDU priority mark, PPM values.

In an example, the at least one transfer condition is fulfilled when e.g. all data buffers, or those data buffers belonging to certain DRBs (most likely DRBs configured with certain QoS characteristics) are empty, or empty with respect to a certain PDU set or with respect to PDUs with certain higher-priority PPM value(s). The buffers could include downlink-data buffers at the DU or uplink-data buffers indicated by the UE in MAC Buffer-status reports, or both.

After receiving 510 the delaying transfer information 502 from the second network device 140, the first network device 120 delays transmission 515 of reconfiguration message 504 to a terminal device 110 based on the delaying transfer information 502. In an example, the DU could then delay delivering the RRC message to the UE within the delay budget or when the explicit timing and/or the condition is met.

After receiving 525 the reconfiguration message 504 from the first network device 120, the terminal device 110 performs 530 a reconfiguration operation.

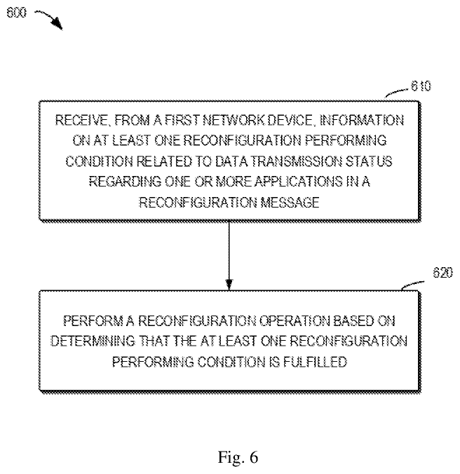

FIG. 6 illustrates an example flowchart of a method implemented at a terminal device 110 according to example embodiments of the present disclosure. For the purpose of discussion, the method 600 will be described from the perspective of the terminal device 110 with reference to FIG. 1. It is to be understood that method 600 may further include additional blocks not shown and/or omit some shown blocks, and the scope of the present disclosure is not limited in this regard.

At block 610, the terminal device 110 may receive, from a first network device 120, indication information on at least one reconfiguration performing condition related to data transfer status regarding one or more applications.

In some embodiments, the at least one reconfiguration performing condition may include ending of an active time for data transmission and reception. In some embodiments, the active time for data transmission and reception includes active time on one or more discontinuous reception, DRX, groups of at least one serving cell.

In some embodiments, the at least one reconfiguration performing condition may include that data amount in an application-layer playout buffer of the terminal device 110 is above a predetermined threshold.

In some embodiments, the at least one reconfiguration performing condition may include transmission completion of all protocol data units, PDU, belonging to a certain PDU set or a certain data radio bearer, or a certain PDU session.

In some embodiments, the at least one reconfiguration performing condition may include transmission completion of all PDUs with a predetermined higher-priority PDU priority mark, PPM.

In some embodiments, the indication information is comprised in a reconfiguration message, and wherein the reconfiguration message includes a radio resource control, RRC, reconfiguration message.

At block 620, the terminal device 110 may perform a reconfiguration operation based on determining that the at least one reconfiguration performing condition is fulfilled.

In some embodiments, the reconfiguration message is used for any of handover between distributed units, change of secondary cell group, SCG, or bearer-type change of a data radio bearer, DRB, among a master cell group, MCG, bearer, a split bearer, and a SCG bearer.

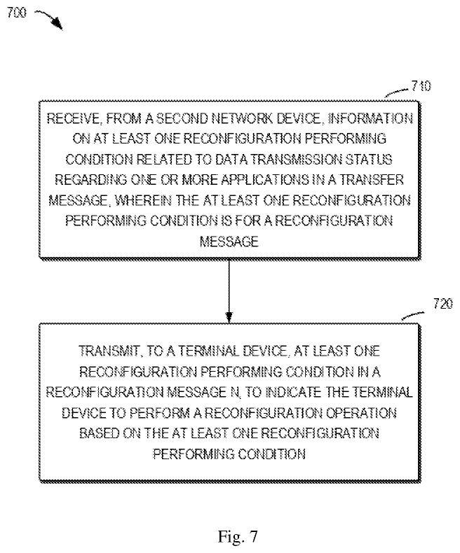

FIG. 7 illustrates an example flowchart of a method implemented at a first network device 120 according to example embodiments of the present disclosure. For the purpose of discussion, the method 700 will be described from the perspective of the first network device 120 with reference to FIG. 1. It is to be understood that method 700 may further include additional blocks not shown and/or omit some shown blocks, and the scope of the present disclosure is not limited in this regard.

At block 710, the first network device 120 may receive, from a second network device 140, indication information on at least one reconfiguration performing condition related to data transfer status regarding one or more applications, wherein the at least one reconfiguration performing condition is for a reconfiguration message.

In some embodiments, the at least one reconfiguration performing condition may include: ending of an active time for data transmission and reception.

In some embodiments, the active time for data transmission and reception may include active time on one or more discontinuous reception, DRX, groups of at least one serving cell.

In some embodiments, the at least one reconfiguration performing condition may include that data amount in application-layer playout buffer of the terminal device 110 is above a predetermined threshold.

In some embodiments, the at least one reconfiguration performing condition may include transmission completion of all protocol data units, PDU, belonging to a certain PDU set or a certain data radio bearer, or a certain PDU session.

In some embodiments, the at least one reconfiguration performing condition may include transmission completion of all PDUs with predetermined higher-priority PDU priority mark, PPM.

In some embodiments, the indication information received from the second network device is comprised in a transfer message. In some embodiments, the indication information transmitted to the terminal device is contained in the reconfiguration message, and wherein the reconfiguration message comprises a radio resource control, RRC, reconfiguration message.

At block 720, the first network device 120 may transmit, to a terminal device 110, at least one reconfiguration performing condition, to indicate the terminal device 110 to perform a reconfiguration operation based on the at least one reconfiguration performing condition.

In some embodiments, the reconfiguration message is used for any of handover between distributed units, change of secondary cell group, SCG, or bearer-type change of a data radio bearer, DRB, among a master cell group, MCG, bearer, a split bearer, and a SCG bearer.

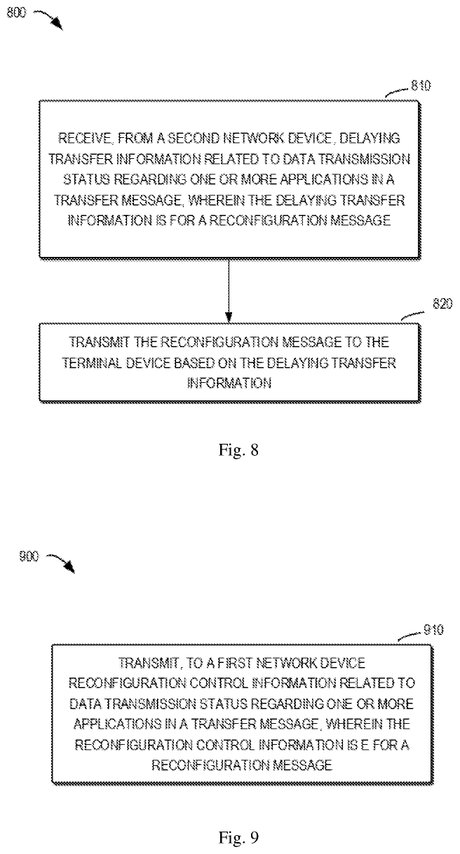

FIG. 8 illustrates an example flowchart of a method implemented at a first network device 120 according to example embodiments of the present disclosure. For the purpose of discussion, the method 800 will be described from the perspective of the first network device 120 with reference to FIG. 1. It is to be understood that method 800 may further include additional blocks not shown and/or omit some shown blocks, and the scope of the present disclosure is not limited in this regard.

At block 810, the first network device 120 may receive, from a second network device 140, delaying transfer information related to data transfer status regarding one or more applications, wherein the delaying transfer information is for a reconfiguration message.

In some embodiments, the delaying transfer information includes one or more of: an indication indicating a non-urgent delivery; a time period within which the reconfiguration message shall be transmitted; or at least one transfer condition for transmitting the reconfiguration message to the terminal device 110.

In some embodiments, the at least one transfer condition includes one or more of: data amount in all data buffers associated with the terminal device is zero or below a certain threshold; or data amount in data buffers belonging to a certain data radio bearer is zero or below a certain threshold.

In some embodiments, the at least one transfer condition includes one or more of: transmission completion of all protocol data units belonging to certain PDU set; or, transmission completion of all protocol data units with predetermined higher-priority PDU priority mark, PPM values.

In some embodiments, the data buffers comprise one or more of: downlink data buffers at the first network device 120; or uplink data buffers indicated by the terminal device 110 in medium access control, MAC, buffer status reports.

In some embodiments, the delaying transfer information is comprised in a transfer message. In some embodiments, the transfer message includes a downlink, DL, radio resource control, RRC, transfer message.

At block 820, the first network device 120 may transmit the reconfiguration message to the terminal device 110 based on the delaying transfer information.

In some embodiments, the reconfiguration message is transmitted to the terminal device 110 based on determining that the at least one transfer condition is fulfilled.

In some embodiments, the reconfiguration message is used for any of handover between distributed units, change of secondary cell group, SCG, or bearer-type change of a data radio bearer, DRB, among a master cell group, MCG, bearer, a split bearer, and a SCG bearer.

FIG. 9 illustrates an example flowchart of a method implemented at a second network device 140 according to example embodiments of the present disclosure. For the purpose of discussion, the method 900 will be described from the perspective of the second network device 140 with reference to FIG. 1. It is to be understood that method 900 may further include additional blocks not shown and/or omit some shown blocks, and the scope of the present disclosure is not limited in this regard.

At block 910, the second network device 140 may transmit, to a first network device 120 reconfiguration control information related to data transfer status regarding one or more applications, wherein the reconfiguration control information is for a reconfiguration message.

In some embodiments, the reconfiguration control information indicates at least one reconfiguration performing condition for a terminal device 110 to perform a reconfiguration operation.

In some embodiments, the at least one reconfiguration performing condition includes one or more of: ending of an active time for data transmission and reception; data amount in application-layer playout buffer of the terminal device 110 is above a predetermined threshold; transmission completion of all protocol data units, PDU, belonging to a certain PDU set or a certain data radio bearer; or transmission completion of all PDUs with predetermined higher-priority PDU priority mark, PPM.

In some embodiments, the active time for data transmission and reception includes active time on one or more discontinuous reception, DRX, groups of at least one serving cell.

In some embodiments, the reconfiguration control information includes delaying transfer information allowing a first network device 120 to delay transmission of the reconfiguration message to the terminal device 110.

In some embodiments, the delaying transfer information includes one or more of: an indication indicating a non-urgent delivery; a time period within which the reconfiguration message shall be transmitted; or at least one transfer condition for transmitting the reconfiguration message to the terminal device 110.

In some embodiments, the at least one transfer condition includes one or more of: data amount in all data buffers associated with the terminal device is zero or below a certain threshold; data amount in data buffers belonging to a certain data radio bearer is zero or below a certain threshold; transmission completion of all protocol data units belonging to certain PDU set; or transmission completion of all protocol data units with predetermined higher-priority PDU priority mark, PPM values.

In some embodiments, the data buffers comprise one or more of: downlink data buffers at the first network device 120, or uplink data buffers indicated by a terminal device 110 in medium access control, MAC, buffer status reports.

In some embodiments, the delaying transfer information is comprised in a transfer message, and wherein the transfer message includes a downlink, DL, radio resource control, RRC, transfer message.

In some embodiments, the reconfiguration message is used for any of handover between distributed units, change of secondary cell group, SCG, or bearer-type change of a data radio bearer, DRB, among a master cell group, MCG, bearer, a split bearer, and a SCG bearer.

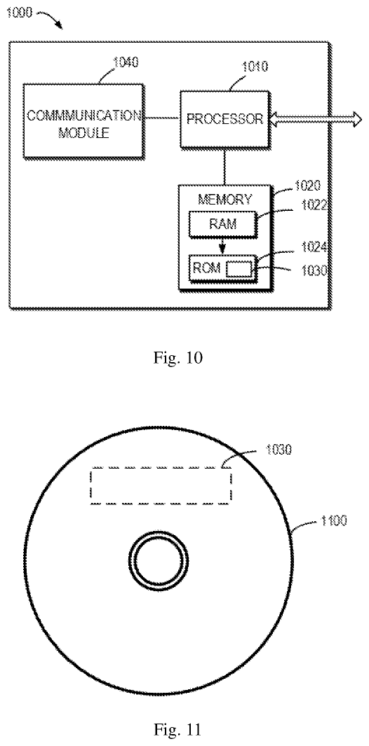

FIG. 10 is a simplified block diagram of a device 1000 that is suitable for implementing embodiments of the present disclosure. The device 1000 may be provided to implement the communication device, for example the terminal device 110 as shown in FIG. 1. As shown, the device 1000 includes one or more processors 1010, one or more memories 1040 coupled to the processor 1010, and one or more transmitters and/or communication modules 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a read only memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program so that the device 1000 may perform any process of the disclosure as discussed with reference to FIG. 2 to FIG. 9. The embodiments of the present disclosure may also be implemented by hardware or by a combination of software and hardware.

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out process 200, process 500, the method 600, 700, 800, or 900 as described above with reference to FIG. 2, FIG. 5 to FIG. 6 to FIG. 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-47. (canceled)

48. A terminal device, comprising:
one or more transceivers; and
one or more processors communicatively coupled to the one or more transceivers, and the one or more processors are configured to cause the terminal device to:
receive, from a first network device, indication information on at least one reconfiguration performing condition related to data transfer status regarding one or more applications; and
perform a reconfiguration operation based on determining that the at least one reconfiguration performing condition is fulfilled.

49. The terminal device according to claim 48, wherein the at least one reconfiguration performing condition comprises:
ending of an active time for data transmission and reception.

50. The terminal device according to claim 49, wherein the active time for data transmission and reception comprises active time on one or more discontinuous reception, DRX, groups of at least one serving cell.

51. The terminal device according to claim 48, wherein the at least one reconfiguration performing condition comprises that data amount in an application-layer playout buffer of the terminal device is above a predetermined threshold.

52. The terminal device according to claim 48, wherein the at least one reconfiguration performing condition comprises transmission completion of all protocol data units, PDU, belonging to a certain PDU set or a certain data radio bearer, or a certain PDU session.

53. The terminal device according to claim 48, wherein the at least one reconfiguration performing condition comprises transmission completion of all PDUs with a predetermined higher-priority PDU priority mark, PPM.

54. The terminal device according to claim 48, wherein the indication information is comprised in a reconfiguration message, and wherein the reconfiguration message comprises a radio resource control, RRC, reconfiguration message.

55. The terminal device according to claim 48, wherein the reconfiguration message is used for any of handover between distributed units, change of secondary cell group, SCG, or bearer-type change of a data radio bearer, DRB, among a master cell group, MCG, bearer, a split bearer, and a SCG bearer.

56. A first network device, comprising:
one or more transceivers; and
one or more processors communicatively coupled to the one or more transceivers, and the one or more processors are configured to cause the first network device to:
receive, from a second network device, indication information on at least one reconfiguration performing condition related to data transfer status regarding one or more applications wherein the at least one reconfiguration performing condition is for a reconfiguration message; and
transmit, to a terminal device, the indication information on at least one reconfiguration performing condition, to indicate the terminal device to perform a reconfiguration operation based on the at least one reconfiguration performing condition.

57. The first network device according to claim 56, wherein the at least one reconfiguration performing condition comprises:
ending of an active time for data transmission and reception.

58. The first network device according to claim 57, wherein the active time for data transmission and reception comprises active time on one or more discontinuous reception, DRX, groups of at least one serving cell.

59. The first network device according to claim 56, wherein the at least one reconfiguration performing condition comprises that data amount in application-layer playout buffer of the terminal device is above a predetermined threshold.

60. An apparatus of a terminal device, comprising:
means for receiving, from a first network device, indication information on at least one reconfiguration performing condition related to data transfer status regarding one or more applications; and
means for performing a reconfiguration operation based on determining that the at least one reconfiguration performing condition is fulfilled.

61. The apparatus of a terminal device according to claim 60, wherein the at least one reconfiguration performing condition comprises:
ending of an active time for data transmission and reception.

62. The apparatus of a terminal device according to claim 61, wherein the active time for data transmission and reception comprises active time on one or more discontinuous reception, DRX, groups of at least one serving cell.

63. The apparatus of a terminal device according to claim 60, wherein the at least one reconfiguration performing condition comprises that data amount in an application-layer playout buffer of the terminal device is above a predetermined threshold.

64. The apparatus of a terminal device according to claim 60, wherein the at least one reconfiguration performing condition comprises transmission completion of all protocol data units, PDU, belonging to a certain PDU set or a certain data radio bearer, or a certain PDU session.

65. The apparatus of a terminal device according to claim 60, wherein the at least one reconfiguration performing condition comprises transmission completion of all PDUs with a predetermined higher-priority PDU priority mark, PPM.

66. The apparatus of a terminal device according to claim 60, wherein the indication information is comprised in a reconfiguration message, and wherein the reconfiguration message comprises a radio resource control, RRC, reconfiguration message.

67. The apparatus of a terminal device according to claim 60, wherein the reconfiguration message is used for any of handover between distributed units, change of secondary cell group, SCG, or bearer-type change of a data radio bearer, DRB, among a master cell group, MCG, bearer, a split bearer, and a SCG bearer.
